(19) United States
(12) Patent Application Publication
(10) Pub. No.: US 2008/0250475 A1
(43) Pub. Date: Oct. 9, 2008

(54) AUTOMATICALLY CHANGING THE APPEARANCE OF A SOFTPHONE BASED ON A USER PROFILE

(75) Inventors: Wee Sin Tam, Singapore (SG); Meng Kim Tan, Singapore (SG)

Correspondence Address: FENWICK & WEST LLP, SILICON VALLEY CENTER, 801 CALIFORNIA STREET, MOUNTAIN VIEW, CA, 94041, US

(73) Assignee: MediaRing Limited, Singapore (SG)

(21) Appl. No.: 12/062,798

(22) Filed: Apr. 4, 2008

Related U.S. Application Data
(60) Provisional application No. 60/922,237, filed on Apr. 5, 2007.

(51) Int. Cl. G06F 3/048; H04L 9/32; G06F 15/16

(52) U.S. Cl. 726/3; 715/716; 709/203

(57) ABSTRACT

A software phone (“softphone”) application enables a user to make a phone call from a computing device user Voice over Internet Protocol (VoIP). While the functionality of the softphone remains the same, its appearance is defined by a skin that can be changed. A server stores a profile for users of the softphone. Based on the user profile, the server selects a skin and pushes the skin to the user's softphone, thereby changing the appearance of the softphone. The skin can include advertisement and can include several layers that can be displayed simultaneously. Some of the layers are static, and some of the layers are animated.

### CROSS REFERENCE TO RELATED APPLICATIONS

This application claims the benefit of U.S. Provisional Patent Application No. 60/922,237, filed Apr. 5, 2007, entitled “Automatically Changing a Softphone's Appearance Based on a User Profile,” the contents of which are hereby incorporated by reference in its entirety.

### BACKGROUND

1. Field of Art

The disclosure generally relates to the field of graphical user interfaces, and in particular to changing the appearance of a graphical user interface of a softphone application based on a user profile.

2. Description of the Related Art

A software phone (“softphone”) application enables a user to make a phone call from a computing device using Voice over Internet Protocol (VoIP). While the functionality of the softphone is constant, the appearance of the softphone is defined by a skin that can be changed. Various information and graphics may be displayed on the skin and the appearance of the skin is usually the default design that was created by the software application supplier. Sometimes, however, users can customize the skin according to the user's preference. Currently, the users are the ones who chose the appearance of their own skin. Additionally, currently, if a user desires a different appearance for their softphone, they must make the effort themselves to change the appearance as it is not done automatically.

### SUMMARY

A software phone (“softphone”) application enables a user to make a phone call from a computing device using Voice over Internet Protocol (VoIP). While the functionality of the softphone remains the same, the softphone's appearance is defined by a skin that can be changed. A server stores a profile for users of the softphone. Based on the user profile, the server selects a skin and pushes the skin to the user's softphone, thereby changing the appearance of the softphone. The skin can include advertisements. The advertisements can include several layers that can be displayed simultaneously. Some of the layers are static, and some of the layers are animated.

One embodiment of a disclosed system includes a VoIP server for receiving a login request from a client device, and for retrieving user profile information based on the login request. The system also includes an advertisement server, adapted to communicate with the VoIP server, for receiving user profile information, retrieving advertisement content based on the retrieved user information, generating an advertisement campaign based on the advertisement content, and sending the advertisement content for display on the user interface of the softphone.

In one embodiment, a method for changing the appearance of a user interface of a softphone includes: receiving a login request from a client device; retrieving user information based on the login request; retrieving advertisement content based on the retrieved user information; generating an advertisement campaign based on the advertisement content; and sending the advertisement campaign for display on the user interface of the softphone.

The features and advantages described in the specification are not all inclusive and, in particular, many additional features and advantages will be apparent to one of ordinary skill in the art in view of the drawings, specification and claims. Moreover, it should be noted that the language used in the specification has been principally selected for readability and instructional purposes, and may not have been selected to delineate or circumscribe the disclosed subject matter.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 shows an environment adapted to support automatically changing the appearance of a softphone according to one embodiment.

FIG. 2 is a high-level block diagram illustrating a functional view of a typical computer for use as one of the entities illustrated in the environment of FIG. 1 according to one embodiment.

FIG. 3 is a high-level block diagram illustrating modules within a Voice over Internet Protocol (VoIP) server according to one embodiment.

FIG. 4 is a high-level block diagram illustrating modules within an advertisement server according to one embodiment.

FIG. 5A is a flow chart illustrating the interaction between a client, VoIP server and advertisement server according to one embodiment.

FIG. 5B is a flow chart illustrating the interaction between a client, VoIP server and advertisement server according to another embodiment.

FIG. 6 is a graphic representation of an exemplary user interface illustrating a first layer of a user interface of a softphone according to one embodiment.

FIG. 7 is a graphic representation of an exemplary user interface illustrating a second layer of a softphone according to one embodiment.

FIG. 8 is a graphic representation of an exemplary user interface illustrating a third layer of a softphone according to one embodiment.

FIG. 9A a graphic representation of three layers of an exemplary user interface of a softphone according to one embodiment.

FIG. 9B is a graphic representation of an exemplary user interface illustrating the combination of various layers of a user interface skin of a softphone according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

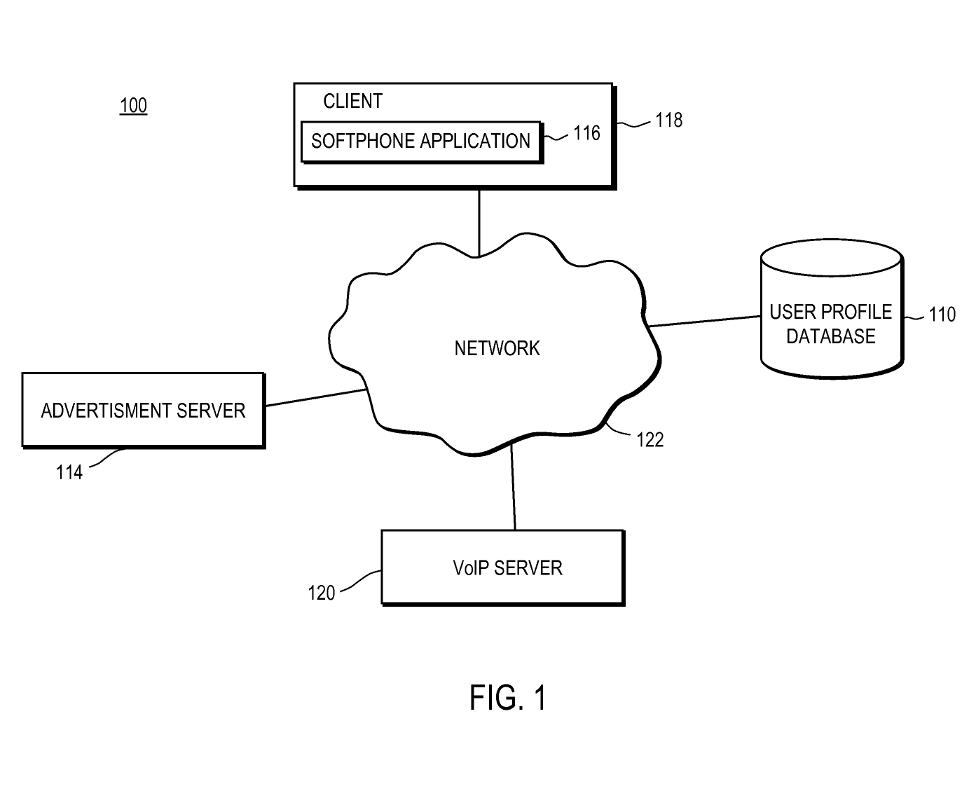

FIG. 1 shows an environment 100 adapted to support automatically changing the appearance of a softphone according to one embodiment. The environment 100 includes a Voice over Internet Protocol (VoIP) server 120, a user profile database 110 and an advertisement server 114. The environment 100 also includes a client 118 for allowing a user to utilize the VoIP server 120 to make and receive Internet Protocol (IP) calls over the network 122. A network 122 enables communications between and among the VoIP server 120, the user profile database 110, the advertisement server 114 and the client 118.

Each of the various servers is implemented as server program executing on server-class computer comprising a CPU, memory, network interface, peripheral interfaces and other well known components. The computers themselves preferably run an open-source operating system such as LINUX, have generally high performance CPUs, 1 G or more of memory, and 100 G or more of disk storage. Of course, other types of computers can be used, and it is expected that as more powerful computers are developed in the future, they can be configured in accordance with the teachings here. The functionality implemented by any of the elements can be provided from computer program products that are stored in tangible computer accessible storage mediums (e.g., RAM, hard disk, or optical/magnetic media).

A client 118 executes a softphone application 116, and can connect to the VoIP server 120 and the advertisement server 114 via a network 122, which is typically the Internet, but may also be any network, including but not limited to any combination of a LAN, a MAN, a WAN, a mobile, wired or wireless network, a private network, or a virtual private network. While only a single client 118 and softphone application 116 are shown, it is understood that very large numbers (e.g., millions) of clients are supported and can be in communication with the VoIP server 120 and the advertisement server 114 via at any time.

In one embodiment, the client 118 is an electronic device for interacting with the VoIP server 120, and in other embodiments, the client 118 is an electronic device that is also adapted to interact with the advertisement sever 114. The client 118 can be, for example, a notebook, desktop, or handheld computer, a mobile telephone, personal digital assistant (PDA), mobile email device, portable game player, portable music player, computer integrated into a vehicle, etc.

The softphone application 116 of the client 118 presents the user with a graphical interface of the softphone application 116 (the softphone) on the display of the client 118 that provides access to various telephone functions, for example, dialing, answering machine, call log and number directory. The softphone application 116 generates telephone-signaling information and converts the signaling information and compressed audio stream into packets. The softphone application 116 may also use the microphone, the speaker and the sound card of the computer to provide two-way voice communication from client 118 to another client 118. The softphone application 116 allows the user of the client 118 to communication with other clients 118 by using the services of the VoIP server 120 via the network 122.

The user profile database 110 stores user profiles for each user. A user profile includes information associated a the user of a client 118 and represents characteristics of the user. In some embodiments, information associated with the user includes information associated with a user's user identification (user ID), the user's names, the user's login information or credentials, the user's residential location, including city, state and county, the user's email address, a username, the user's country of residence, the user's date of birth, the user's gender, the user's age, as well as other additional information related to the particular user. In other embodiments, the information associated with the user also includes the user's telephone contacts, which include the telephone number of the contact. The information associated with the user may also include information associated with the user's interests, income, occupation, ethnic group and organizations. For example, in one embodiment, a list of hobbies of the user is associated with a user ID and other related user information and is stored in the user profile database 110.

In one embodiment, as the user uses the services provided by the VoIP server 120, additional information is added to the user profile of that user and stored in the user profile database 110. In some embodiments, the location of the calls made by the user is added as users make calls through the VoIP server 120. This information may be obtained by determining the IP address of the user. In other embodiments, the destination of the calls that the user makes is added to the user profile. In yet other embodiments, the frequency of each call is added to the user profile. In some embodiments, the times of the day or days of the week that the user makes a call through the VoIP server 120 is added to the user profile. The above-mentioned information stored in the user profile of the user profile database 110 will be later used by the advertisement server 114 to determine what advertisement content to relay to the user of the client 118.

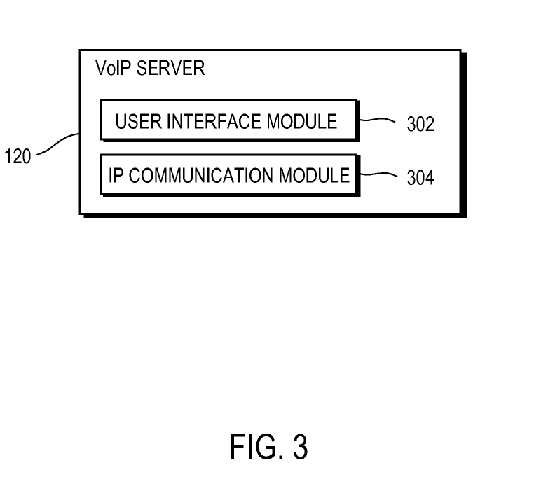

The Voice over Internet Protocol (VoIP) server 120 interacts with the client 118 to enable client-to-client communication over the network 122 and to provide information from the advertisement server 114. The VoIP server 120 includes a User Interface (UI) module 302 and an Internet Protocol (IP) communication module 304. More details describing the modules and functionality of the VoIP server 120 are provided below in the description for FIG. 3.

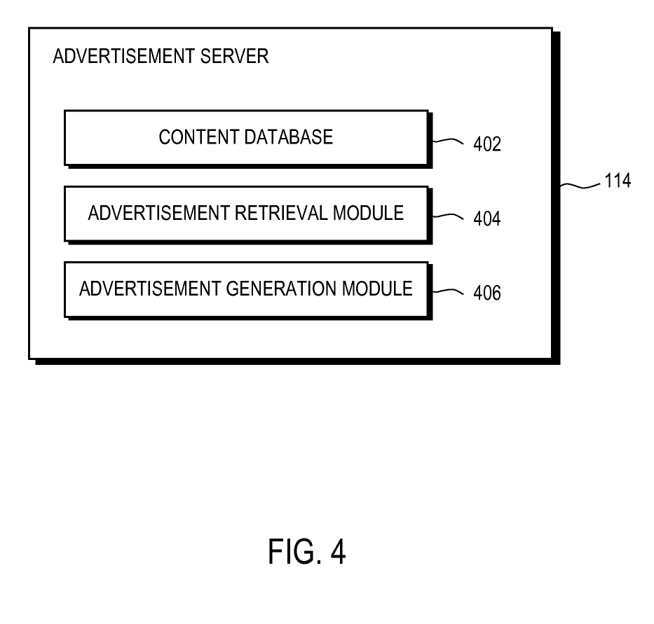

The advertisement server 114 pushes advertisement content to the client 118. In some embodiments, the advertisement server 114 sends the advertisement content to the VoIP server 120 and the UI module 302 of the VoIP server 120 sends the advertisement content to be displayed on the client 118. In another embodiment, the advertisement server 114 sends the advertisement content directly to the client 118 through the network 122. The advertisement server 114 includes a content database 402, an advertisement retrieval module 404 and an advertisement generation module 406. More details describing the modules and functionality of the advertisement server 114 are provided below in the description for FIG. 4.

The network 122 represents communication pathways between the VoIP server 120, user profile database 110, advertisement server 114 and client 118. In one embodiment, the network 122 is the Internet. The network 122 can also utilize dedicated or private communications links that are not necessarily part of the Internet. In one embodiment, the network 122 uses standard communications technologies, protocols and/or interprocess communications techniques. Thus, the network 122 can include links using technologies such as Ethernet, 802.11, integrated services digital network (ISDN), digital subscriber line (DSL), asynchronous transfer mode (ATM), etc. Similarly, the networking protocols used on the network 122 can include the transmission control protocol/Internet protocol (TCP/IP), the hypertext transport protocol (HTTP), the simple mail transfer protocol (SMTP), the file transfer protocol (FTP), the short message service (SMS) protocol, etc. The data exchanged over the network 122 can be represented using technologies and/or formats including the hypertext markup language (HTML), the extensible markup language (XML), etc. In addition, all or some of links can be encrypted using conventional encryption technologies such as the secure sockets layer (SSL), HTTP over SSL (HTTPS) and/or virtual private networks (VPNs). In another embodiment, the nodes can use custom and/or dedicated data communications technologies instead of, or in addition to, the ones described above.

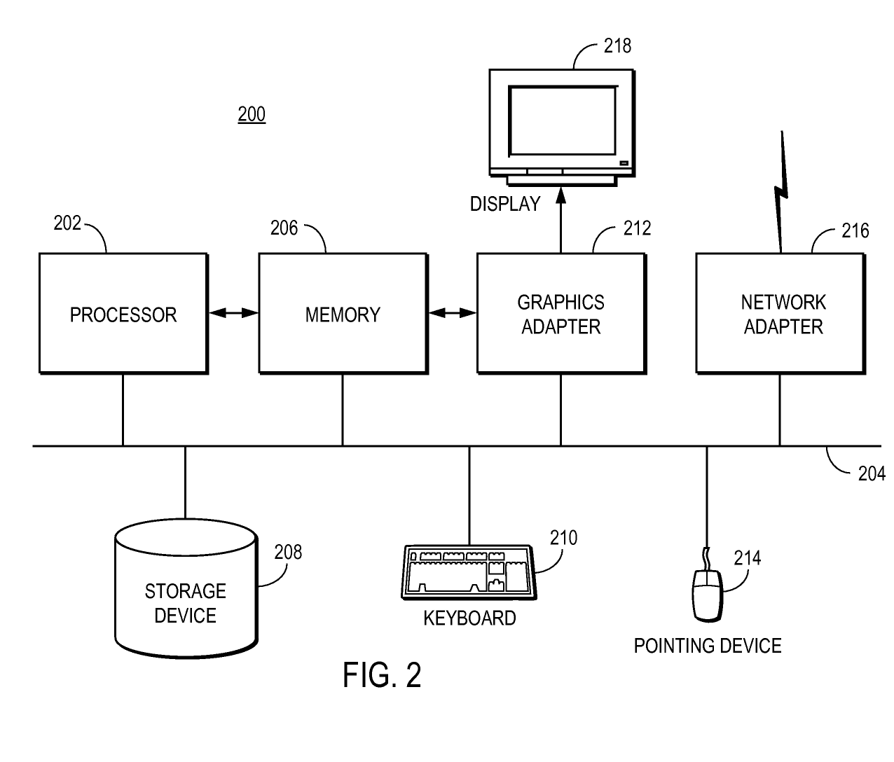

FIG. 2 is a high-level block diagram illustrating a functional view of a typical computer 200 for use as one or more of the entities illustrated in the environment 100 of FIG. 1 according to one embodiment. Illustrated are at least one processor 202 coupled to a bus 204. Also coupled to the bus 204 are a memory 206, a storage device 208, a keyboard 210, a graphics adapter 212, a pointing device 214 and a network adapter 216. A display 218 is coupled to the graphics adapter 212.

The processor 202 may be any general-purpose processor such as an INTEL x86 compatible-CPU. The storage device 208 is any device capable of holding data, like a hard drive, compact disk read-only memory (CD-ROM), DVD, or a solid-state memory device. The memory 206 holds instructions and data used by the processor 202 and may be, for example, firmware, read-only memory (ROM), non-volatile random access memory (NVRAM) and/or RAM, and holds instructions and data used by the processor 202. The pointing device 214 may be a mouse, track ball, or other type of pointing device, and is used in combination with the keyboard 210 to input data into the computer system 200. The graphics adapter 212 displays images and other information on the display 218. The network adapter 216 couples the computer system 200 to the network 122.

As is known in the art, the computer 200 is adapted to execute computer program modules. As used herein, the term “module” refers to computer program logic and/or data for providing the specified functionality. A module can be implemented in hardware, firmware and/or software. In one embodiment, the modules are stored on the storage device 208, loaded into the memory 206, and executed by the processor 202 as one or more processes.

The types of computers used by the entities of FIG. 1 can vary depending upon the embodiment and the processing power utilized by the entity. For example, the client 118 typically requires less processing power than the VoIP server 120 and the advertisement server 114. Thus, the client 118 system can be a standard personal computer or a mobile telephone. The VoIP server 120 and the advertisement server 114, in contrast, may comprise processes executing on more powerful computers, logical processing units and/or multiple computers working together to provide the functionality described herein. Further, the VoIP server 120 and the advertisement server 114 might lack devices that are not required to operate them, such as displays 218, keyboards 210 and pointing devices 214.

Embodiments of the entities described herein can include other and/or different modules than the ones described here. In addition, the functionality attributed to the modules can be performed by other or different modules in other embodiments. Moreover, this description occasionally omits the term “module” for purposes of clarity and convenience.

FIG. 3 is a high-level block diagram illustrating modules within the VoIP server 120 according to one embodiment. The VoIP server 120 interacts with the client 118 to enable client-to-client communication over the network 122 and to provide information from the advertisement server 114. The VoIP server 120 includes a user interface (UI) module 302 and an IP communication module 304. In one embodiment, the User Interface (UI) module 302 communicates with the client 118 to receive and present information.

The VoIP server 120 also includes an Internet Protocol (IP) communication module 304 that allows client 118 to communication with other clients 118 through the network 122. For example, the UI module 302 may receive a call request from a user of the client 118, and the IP communication module 304 may initiate the call request to a second client. The IP communication module 304 also receives login requests from client 118 and communicates with the user profile database 110 through the network 122 in order to authenticate the client's 118 login request. After authentication, the IP communication module 304 also retrieves the user information stored in the user profile database 110. The user information may include the user's residential location, the user's email address, a username, the user's country of residence, the user's date of birth, the user's gender, the user's age, as well as other additional information related to the user as described above. In some embodiments, the IP communication module 304 of the VoIP server 120 sends the user information to the client 118. In other embodiments the VoIP server 120 sends the user information to the advertisement server 114. In these embodiments, the UI module 302 of the VoIP server 120 also receives generated advertisement content from the advertisement server 114 and sends the advertisement content to the client 118 for display on the graphical user interface of the softphone of the client 118.

For purposes of illustration, FIG. 3 shows the UI module 302 and the IP communication module 304 as discrete modules. However, in various embodiments, the UI module 302 and the IP communication module 304 can be combined. This allows a single module to perform the functions of the two above-described modules.

FIG. 4 is a high-level block diagram illustrating modules within the advertisement server 114 according to one embodiment. An embodiment of the advertisement server 114 sends advertisement content directly to the client 118 through the network 122 to be displayed on the client 118. Another embodiment of the advertisement server 114 sends advertisement content through the network 122 to the VoIP server 120 which in turn sends the advertisement content through the network 122 to the client 118 to be displayed on the client 118. The advertisement server 114 includes a content database 402, an advertisement retrieval module 404 and an advertisement generation module 406. Some embodiments have different and/or additional modules than those shown in FIG. 4. Moreover, the functionalities can be distributed among the modules in a different manner than described here.

The content database 402 of the advertisement server 114 stores information associated with various advertisements. In some embodiments, each advertisement for a respective product is stored in the content database 402 as an advertisement campaign. Each campaign is tagged in a manner such that each campaign is associated with particular user characteristics. For example, one advertisement campaign may be tagged such that the campaign is associated with users who are interested in sports. Another advertisement campaign may be tagged such that the campaign is associated with users who live in Singapore. In some embodiments, an advertisement campaign is tagged such that it is associated with more than one user characteristic. For example, an advertisement campaign may be tagged such that the campaign is associated with women who are over forty years old and practice law. The content database 402 of the advertisement server 114 stores the information associated with the advertisement campaign, such as the text of the advertisement, graphics of brand logos, or other information related to the advertisement campaign. For example, an advertisement for NIKE® may include the NIKE® logo, the slogan, “JUST DO IT”™, and a picture of Michael Jordan. Such campaign may be tagged as being associated with users with an interest in professional basketball.

In some embodiments, the content database 402 stores ringtones. Similar to the advertisement campaign, the ringtones are also tagged in a manner such that each ringtone is associated with a user characteristic. For examples, a ringtone producing classical music may be tagged such that the ringtone is associated with users who are interested in classical music. As another example, a ringtone producing a particular sports anthem may be tagged such that the ringtone is associated with users who are interested in sports. As yes another example, a ringtone producing a popular song may be tagged such that the ringtone is associated with users who are between the ages of eighteen and twenty four.

The advertisement retrieval module 404 of the advertisement server 114 retrieves user profile information from the user profile database 110. The advertisement retrieval module 404 analyzes the user profile information and retrieves the advertisement campaign, or ringtone, from the content database 402 based on the user profile information. The advertisement retrieval module 404 compares the user profile information with the user characteristics tagged onto the advertisement campaigns stored in the content database 402 in order to determine which advertisement campaign to retrieve. For example, if the user information includes information indicating that the user is interested in sports, the advertisement retrieval module 404 retrieves an advertisement campaign that is tagged with users who are interested in sports. In some embodiments, if there is more than one advertisement campaign tagged with users who are interested in sports, the advertisement campaign may be selected randomly from the advertisement campaigns tagged with users who are interested in sports. In other embodiments, if there is more than one advertisement campaign tagged with users who are interested in sports, the selection may be based on a ranking of the advertisement campaign.

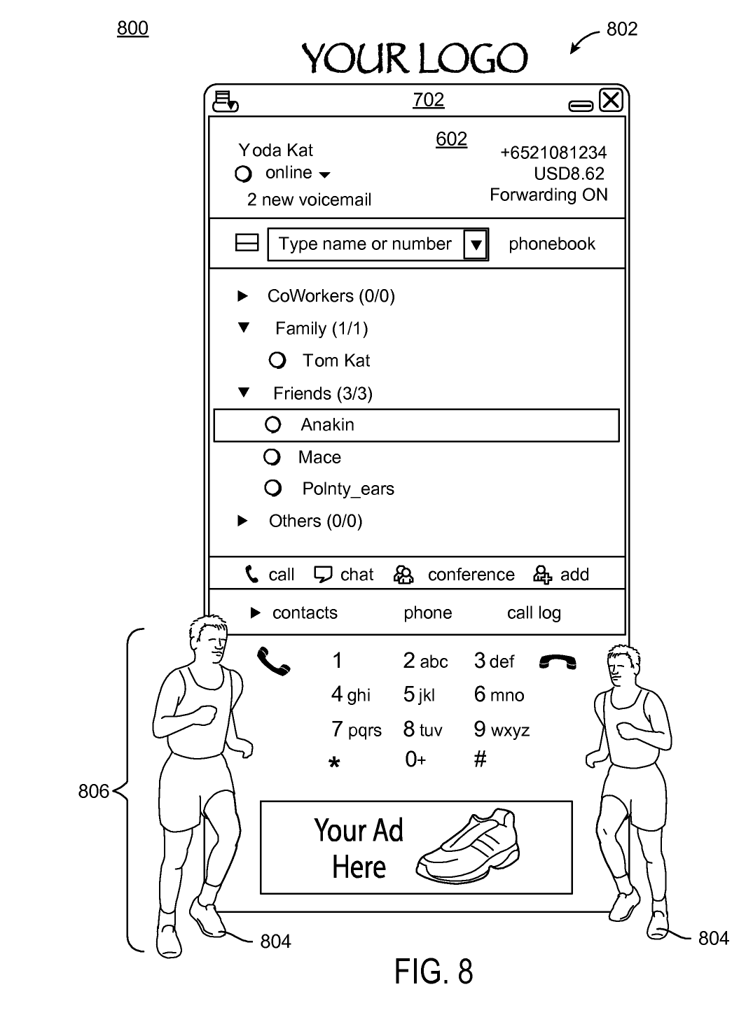

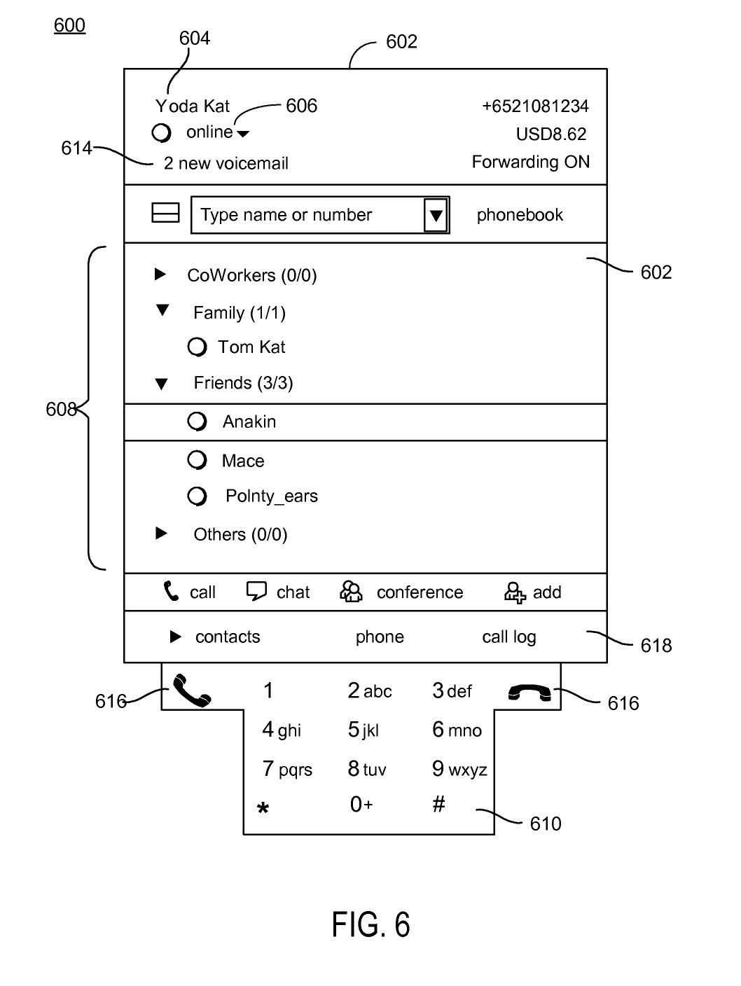

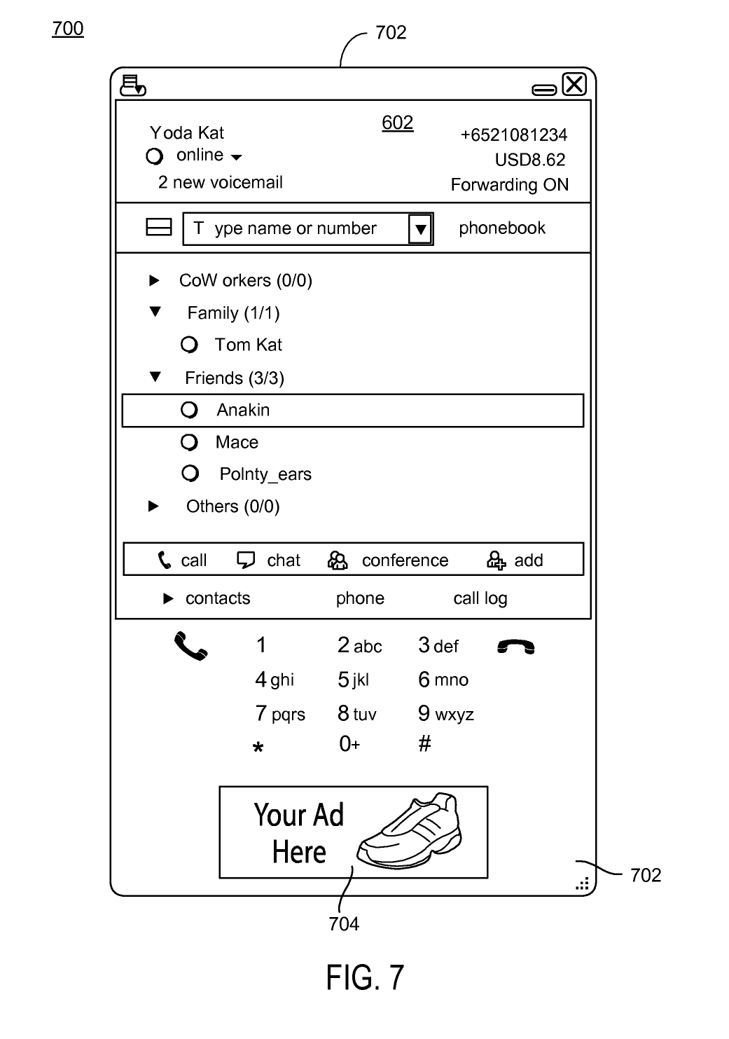

The advertisement generation module 406 of the advertisement server 114 generates graphical representations of advertisement content in accordance to the advertisement content retrieved by the advertisement retrieval module 404. In one embodiment, the advertisement generation module 406 generates the graphical representations as skin advertisements in separate layers that are displayed simultaneously on the user interface of a softphone. In one embodiment, a first layer 602 is generated. The first layer 602 includes the basic features to enable the functionality of a softphone. For example, FIG. 6 shows a first layer 602, which includes a username 604, a user status 606, a contact list 608 and a dial pad 610. In some embodiments, the features of the first layer 602 (a user status 606, a contact list 608 and a dial pad 610) are presented in a different arrangement. In other embodiments, the features of the first layer 602 may also include additional designs based on the retrieved user information. As shown in FIG. 7, second layer 702 is also generated. The second layer 702 includes a static skin area that is incorporated into the first layer. The second layer 702 includes text or graphics related to the advertisement. The second layer 702 displayed simultaneously with the first layer 602. As shown in FIG. 7, the second layer 702, or static skin layer, includes an advertisement in the form of a banner 704. As shown in FIG. 8, third layer 802 is also generated. The third layer 802 includes the animated skin area 806, which can be created using a FLASH™ player. The third layer 802 displayed simultaneously with the first layer 602 and second layer 702. In the third layer 802, the characters 804 of the third layer 802 are animated and can move around.

In one embodiment, the advertisement generation module 406 sends the advertisement campaign to the VoIP server 120 which is in turn sent to the client 118 for display on the graphical user interface of the softphone of the client 118. In other embodiments, the advertisement generation module 406 sends the advertisement campaign directly to the client 118 for display on the graphical user interface of the softphone of the client 118. In some embodiments, the advertisement campaign includes all of the layers. In other embodiments, the advertisement campaign includes only one or some of the layers.

For purposes of illustration, FIG. 4 shows the advertisement retrieval module 404 and the advertisement generation module 406 as discrete module. However, in various embodiments, the advertisement retrieval module 404 and the advertisement generation module 406 can be combined. This allows a single module to perform the functions of the two above-described modules.

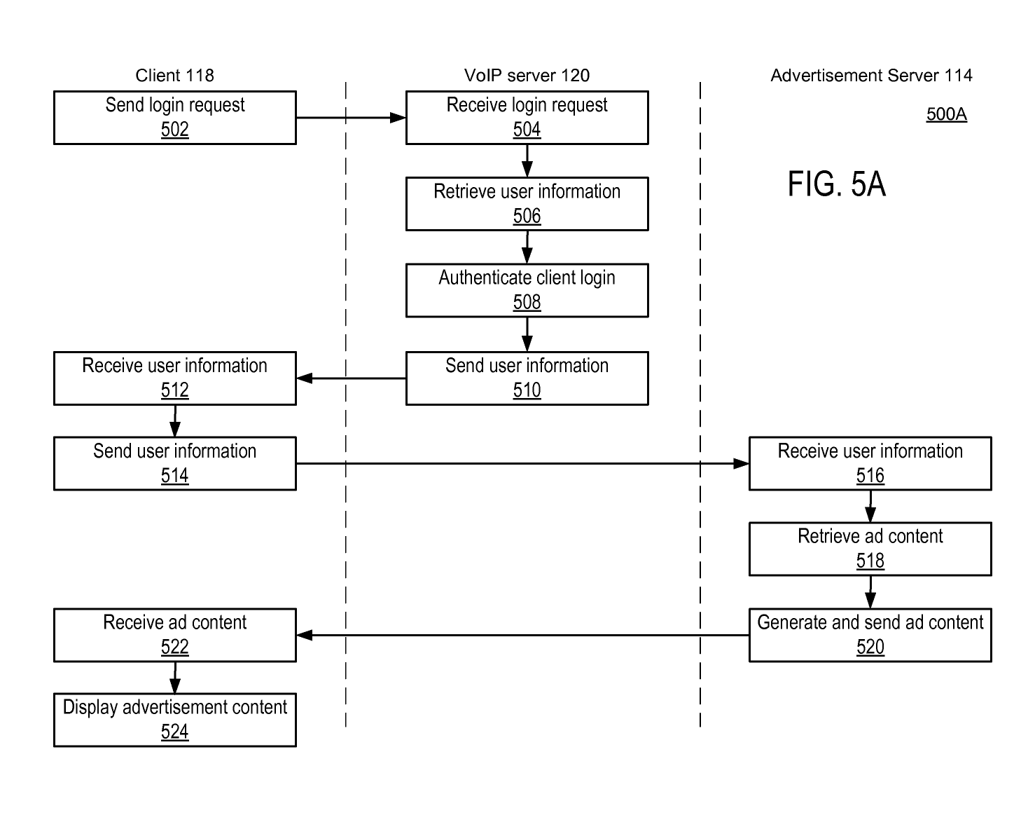

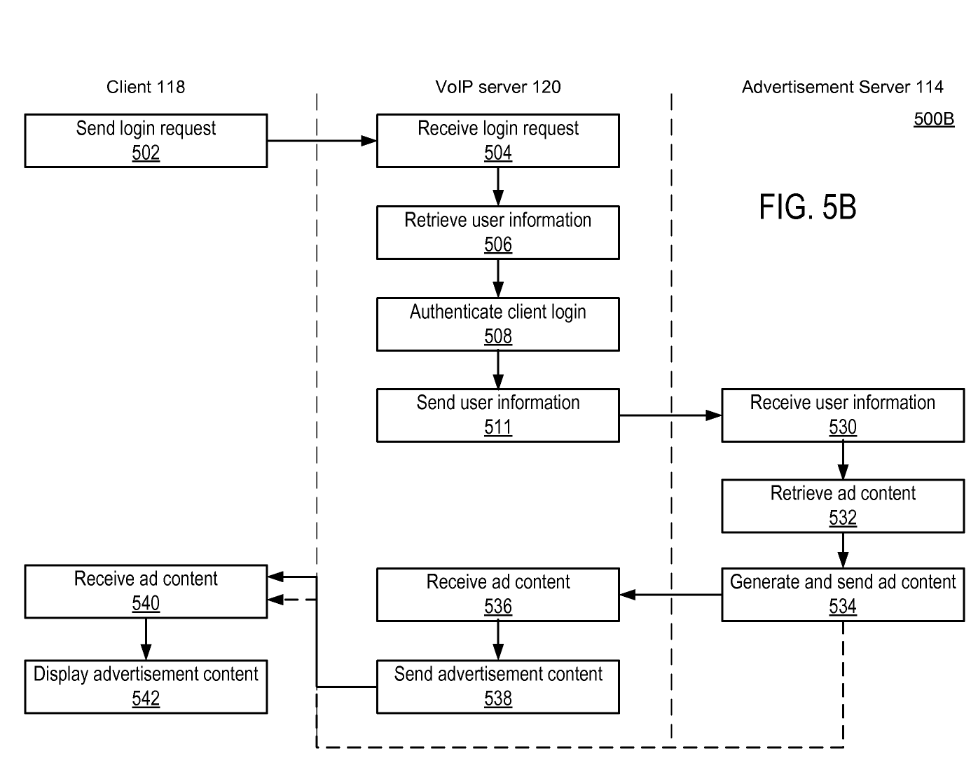

FIG. 5A is a flow chart 500A illustrating the interaction between the client 118, VoIP server 120 and advertisement server 114 according to one embodiment. Other embodiments may perform different or additional steps than the ones shown in FIG. 4

A user submits a login request by entering the user's login credentials, such as a username and password on a client 118 and the login request is sent 502 to the VoIP server 120. The VoIP server 120 receives 504 the login request from the client 118. The VoIP server 120 retrieves 506 the user's information from the user profile database 110. The VoIP server 120 then authenticates 508 the client login by comparing the received login information and the information available in the user profile database 110. The VoIP server 120 then sends 511 the user information to the client 118. The user information that is sent includes the information associated with the user that is stored in the user profile database 110, such as the user's residential location, the user's email address, a username, the user's country of residence, the user's date of birth, the user's gender, the user's age, as well as other additional information related to the user. The user information also includes the IP address of the client 118 from which the user has sent the login request. The client 118 receives 512 the user information and sends 514 the user information to the advertisement server 114. The advertisement server 114 receives the user information and retrieves 518 advertisement content based on the user information. The advertisement server 114 sends 520 the advertisement content to the client 118 based on the IP address of the client 118. The client 118 receives 522 the advertisement content, which is then displayed 524 on the softphone on the display of the client 118. The display of the advertisement content changes the appearance of the graphical user interface of the softphone of the client 118.

FIG. 5B is a flow chart 500B illustrating the interaction between the client 118, the VoIP server 120 and the advertisement server 114 according to another embodiment. Other embodiments may perform different or additional steps than the ones shown in FIG. 4

Similar to the above method, user submits a login request by entering the user's login credentials, such as a username and password on a client 118 and the login request is sent 502 to the VoIP server 120. The VoIP server 120 receives 504 the login request from the client 118. The VoIP server 120 retrieves 506 the user's information from the user profile database 110. The VoIP server 120 then authenticates 508 the client login by comparing the received login information and the information available in the user profile database 110.

In this embodiment, the VoIP server 120 then sends the user information to the advertisement server 114. The user information that is sent includes the information associated with the user that is stored in the user profile database 110, such as the user's residential location, the user's email address, a username, the user's country of residence, the user's date of birth, the user's gender, the user's age, as well as other additional information related to the user. The advertisement server 114 receives 530 the user information and retrieves 532 advertisement content based on the user information. The advertisement server 114 then generates and sends 534 advertisement content to the VoIP server 120. The VoIP server 120 receives 536 the advertisement content and sends 538 the advertisement content to the client 118. The client 118 receives 540 the advertisement content, which is then displayed 542 on the display of the client. In another embodiment, the advertisement server 114 then generates and sends 516 advertisement content directly to the client 118 for display. The display of the advertisement content changes the appearance of the graphical user interface of the softphone of the client 118.

FIG. 6 is an exemplary user interface 600 illustrating basic features of a user interface of a softphone according to one embodiment. The basic features make up a first layer 602, which includes a username 604, a user status 606, a contact list 608 and a dial pad 610, as described above. The first layer 602 may also include a contact field 612, a message notifier 614, call action buttons 616 and an interface status 618. This interface 600 provides access to various telephone functions, such as dialing, answering machine, call log and number directory, as well as chatting and conference calling.

FIG. 7 is an exemplary user interface 700 illustrating a banner advertisement displayed on the user interface of a softphone according to one embodiment. The user interface 700 includes the first layer 602 and a second layer 702. In this example, the second layer 702 includes an advertisement in the form of a banner 704.

FIG. 8 is an exemplary user interface 800 illustrating a user interface skin of a softphone according to one embodiment. The user interface 800 includes a third layer 802. The third layer 802 includes the animated skin area 806, which can be created using a FLASH™ player. The user interface 700 includes a third layer 802, the second layer 702 and the first layer 602. In the third layer 802, the characters 804 of the animated skin area 806 are animated and can move around. These layers 602, 702 and 802 make up the graphical user interface (or skin) of the softphone.

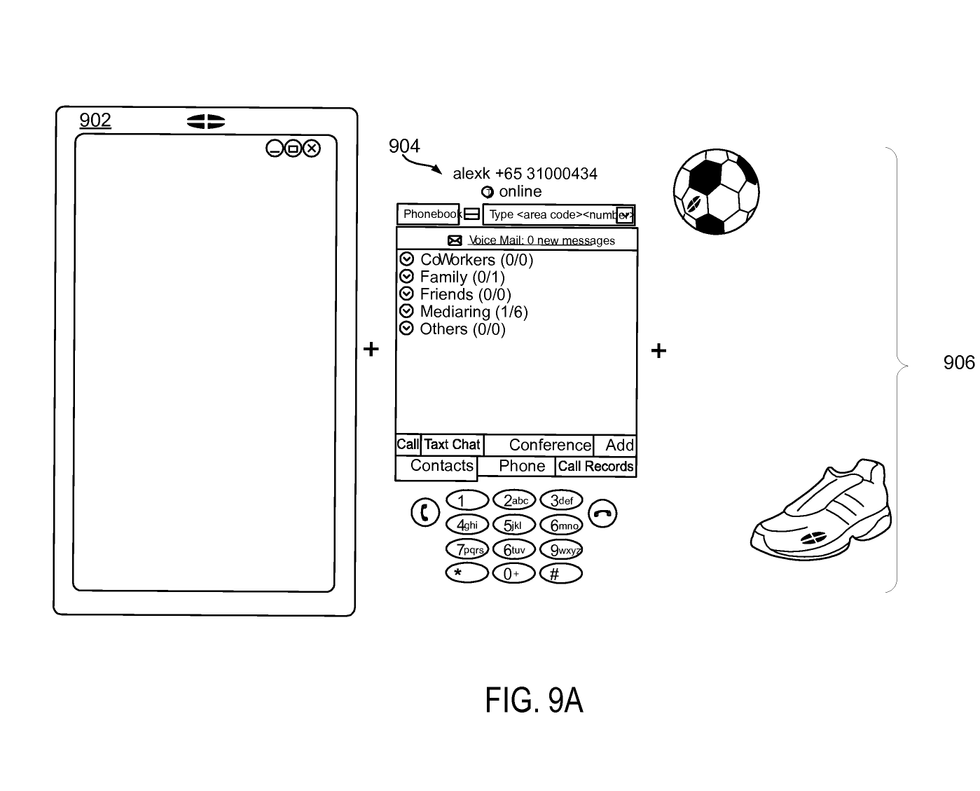

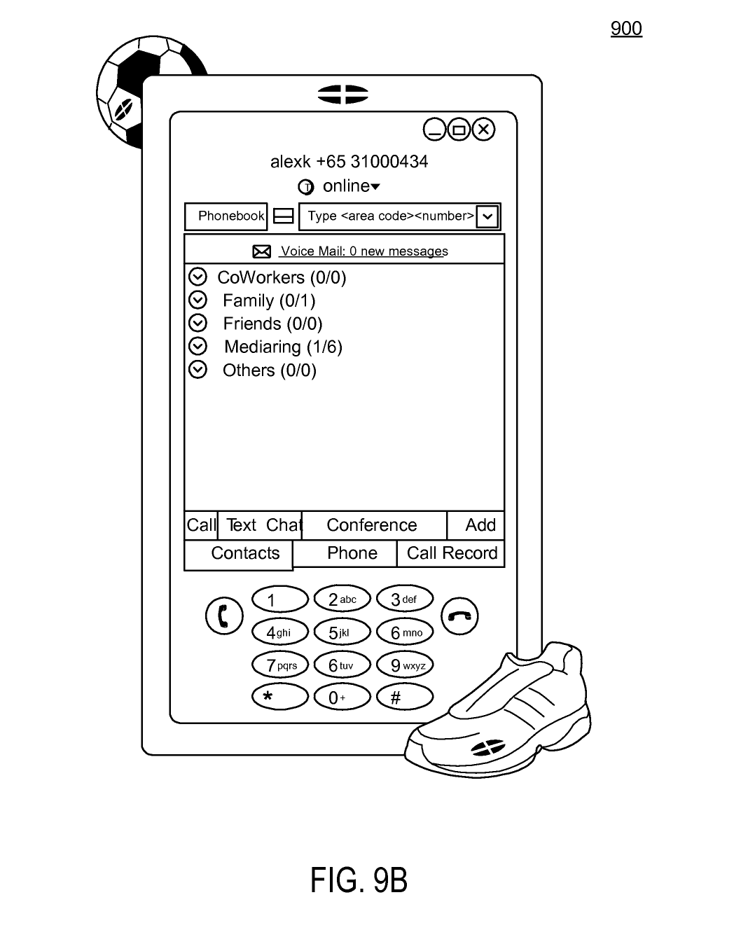

FIG. 9A illustrates the combination of various layers of a user interface skin of a softphone according to one embodiment. For example, a user of a client 118 may login and send a login request to the VoIP server 120. The VoIP server 120 retrieves the user's profile information. In this example, the user profile information that is stored in the user profile database 110 may indicate that the user is interested in sports. The information is sent to the advertisement server 114 and the advertisement server 114 retrieves advertisement content from the content database 402 based on the user profile, i.e. the user's interest in sports. Based on this, the advertisement generation module 406 of the advertisement server 114 generates an advertisement campaign promoting sports. The advertisement campaign includes a second layer 902 (the static layer), a first layer 904 (showing the basic features) and a third layer 906 (the animated layer). The advertisement campaign is sent to the client 118 and is subsequently displayed as a skin of the softphone application 116 (softphone) of the client 118 as user interface 900 (FIG. 9B).

The disclosed embodiments beneficially allow for automatically changing the appearance of the skin of a user interface of a softphone based on a user profile. Advertisers can directly target users based on user characteristics provided by the users.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for automatically changing the appearance of a softphone based on a user profile through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for changing a user interface of a softphone, comprising:
receiving a login request from a client device;
retrieving user information based on the login request;
retrieving user interface content based on the retrieved user information;
generating a graphical representation of a content layer based on the user interface content; and
sending the graphical representation of the content layer for display on the user interface of the softphone.

2. The method of claim 1, further comprising:
authenticating the login request from the client device.

3. The method of claim 1, wherein the user interface content includes an advertisement campaign and generating a graphical representation of a content layer includes generating a graphical representation of the advertisement campaign.

4. The method of claim 3, wherein graphical representation of the advertisement campaign includes at least one layer, wherein the layer is displayed on the user interface of the softphone.

5. The method of claim 3, wherein graphical representation of the advertisement campaign includes at least two layers, wherein the two layers are displayed simultaneously on the user interface of the softphone.

6. The method of claim 3, wherein the advertisement campaign includes a ringtone.

7. The method of claim 1, wherein the user information includes a name of the user, residential location of the user, an email address of the user, a username, a country of residence of the user, a date of birth of the user, a gender of the user, an age of the user, telephone contacts of the user, an interest of the user, an income of the user, an occupation of the user, an ethnic group of the user or organizations of the user.

8. A system for changing a user interface of a softphone, comprising:
a VoIP server for receiving a login request from a client device, and for retrieving user profile information based on the login request;
an advertisement server, adapted to communicate with the VoIP server, for receiving a login request from a client device, retrieving user information based on the login request, retrieving user interface content based on the retrieved user information, generating a graphical representation of a content layer based on the user interface content, and sending the graphical representation of the content layer for display on the user interface of the softphone.

9. The system of claim 8, wherein the VoIP server authenticates the login request from the client device.

10. The system of claim 8, wherein the user interface content includes an advertisement campaign and generating a graphical representation of a content layer includes generating a graphical representation of the advertisement campaign.

11. The system of claim 10, wherein graphical representation of the advertisement campaign includes at least one layer, wherein the layer is displayed on the user interface of the softphone.

12. The system of claim 10, wherein graphical representation of the advertisement campaign includes at least two layers, wherein the two layers are displayed simultaneously on the user interface of the softphone.

13. The system of claim 10, wherein the advertisement campaign includes a ringtone.

14. The system of claim 8, wherein the user information includes a name of the user, residential location of the user, an email address of the user, a username, a country of residence of the user, a date of birth of the user, a gender of the user, an age of the user, telephone contacts of the user, an interest of the user, an income of the user, an occupation of the user, an ethnic group of the user, or organizations of the user.

15. A computer readable medium configured to store instructions, the instructions when executed by a processor cause the processor to:
receive a login request from a client device;
retrieve user information based on the login request;
retrieve user interface content based on the retrieved user information;
generate a graphical representation of a content layer based on the user interface content; and
send the graphical representation of the content layer for display on the user interface of the softphone.

16. The computer readable medium of claim 15, further comprising instructions for authenticating the login request from the client device.

17. The computer readable medium of claim 15, wherein the user interface content includes an advertisement campaign and generating a graphical representation of a content layer includes generating a graphical representation of the advertisement campaign.

18. The computer readable medium of claim 17, wherein graphical representation of the advertisement campaign includes at least one layer, wherein the layer is displayed on the user interface of the softphone.

19. The computer readable medium of claim 17, wherein graphical representation of the advertisement campaign includes at least two layers, wherein the two layers are displayed simultaneously on the user interface of the softphone.

20. The computer readable medium of claim 17, wherein the advertisement campaign includes a ringtone.

21. The computer readable medium of claim 15, wherein the user information includes a name of the user, residential location of the user, an email address of the user, a username, a country of residence of the user, a date of birth of the user, a gender of the user, an age of the user, telephone contacts of the user, an interest of the user, an income of the user, an occupation of the user, an ethnic group of the user, or organizations of the user.
